(19) United States
(12) Patent Application Publication
(10) Pub. No.: US 2022/0237567 A1
(43) Pub. Date: Jul. 28, 2022

(54) CHATBOT SYSTEM AND METHOD FOR APPLYING FOR OPPORTUNITIES

(71) Applicant: ServiceNow, Inc., Santa Clara, CA (US)

(72) Inventors: Mitul Tiwari, Mountain View, CA (US); Ravi N. Raj, Los Altos, CA (US); Kurt William MacDonald, San Jose, CA (US); Quaizar Vohra, Cupertino, CA (US); Srivatsava Daruru, San Jose, CA (US); Madhusudan Mathihalli, Saratoga, CA (US)

(21) Appl. No.: 17/161,390

(22) Filed: Jan. 28, 2021

(51) Int. Cl. G06Q 10/10; G06F 40/174; H04L 12/58

(52) U.S. Cl. CPC G06Q 10/1053; H04L 51/02; G06F 40/174

(57) ABSTRACT

A chatbot system is disclosed that enables users to apply for opportunities (e.g., employment opportunities, educational opportunities, lending opportunities) via a chat interface. For example, a chatbot hosted by the chatbot system can receive a natural language request from a user and determine that the intent of the user message is to submit an application related to opportunity. In response, the chatbot may collect applicant information from various sources (e.g., user documents, social media accounts, user messages) to apply for the opportunity on behalf of the user. The disclosed chatbot system enhances user experience by enabling the application process to proceed via natural language messages and prompts, reducing the amount of applicant information that is provided directly by the user, reducing the number of mistakes in the application process, and maximizing the benefit to the user by enabling the application to multiple or different opportunities with minimal additional effort.

### BACKGROUND

The present disclosure relates generally to creating and implementing conversational interfaces (e.g., chatbots, voice assistants), and more specifically to providing a conservational interface that enables users to apply for opportunities.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

The use of bots in computing systems, including cloud computing systems, is growing rapidly. A bot (also referred to as an “Internet bot”, a “web robot”, and other terms) is a software application that executes various operations (e.g., automated tasks) via the Internet or other data communication network. For example, a bot may perform operations automatically that would otherwise involve significant human effort. Example bots include chatbots that communicate with users via a messaging service, and voice assistants that communicate with users via voice data or other audio data. In some situations, chatbots simulate written or spoken human communications to replace a conversation with a real human person.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Present embodiments are directed to a chatbot system that enables users to apply for opportunities via a chat interface. For example, a chatbot hosted by the chatbot system can receive a message (e.g., a natural language request) from a user and determine that the intent of the user message is to apply for a particular opportunity. In response, the chatbot may collect applicant information from various sources to enable the user to apply for the opportunity. In certain embodiments, the chatbot may receive images of documents supplied by the user via the chat interface and may extract applicant information from these document images. In certain embodiments, the chatbot may access a social media account of the user to extract applicant information. If applicant information to apply for the opportunity cannot be extracted from other sources, the chatbot may prompt the user to provide this additional information via the chat interface. In certain embodiments, the chatbot system enables the user to simultaneously apply for multiple opportunities and/or to apply for opportunities on external services. As such, the disclosed chatbot system enhances the user experience by enabling the application process to proceed via natural language messages and prompts, reducing the amount of applicant information that is provided directly by the user, reducing the number of mistakes in the application process, and maximizing the benefit to the user by enabling the application to multiple or different opportunities with minimal additional effort.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance and hosts a chatbot system, in accordance with aspects of the present disclosure;

FIG. 5 is a block diagram of an embodiment of a chatbot system, in accordance with aspects of the present disclosure;

FIG. 6 is a block diagram of an embodiment of a chatbot, in accordance with aspects of the present disclosure;

FIG. 7 is a block diagram of an embodiment of a framework of the chatbot system that supports conversational artificial intelligence, in accordance with aspects of the present disclosure;

FIG. 8 is a flow diagram of an embodiment of a process whereby the chatbot system responds to messages received from a remote system via a chat interface, in accordance with aspects of the present disclosure;

FIG. 9 is a block diagram of an embodiment of a Recurrent Neural Network (RNN) of the chatbot system having a Long Short-Term Memory (LSTM) architecture, in accordance with aspects of the present disclosure;

FIG. 10 is a flow diagram of an embodiment of a process whereby the chatbot system enables a user to apply for an opportunity via a chat interface, in accordance with aspects of the present disclosure;

FIG. 11 is a flow diagram of an embodiment of a process whereby the chatbot system receives and processes an image of a document supplied by the user to extract applicant information, in accordance with aspects of the present disclosure; and

FIG. 12 is a flow diagram of an embodiment of a process whereby the chatbot system accesses a social media account of the user to extract applicant information, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “opportunity” refers to an offer provided by an entity, such as a business or a service, to which a person (e.g., a user, a customer, a client) can apply via an application. Such an offer may encompass goods or services typically offered by the entity at the standard terms or may also include such goods or services but provided at a discount, for a limited duration, with additional benefits not typically included, and so forth (e.g., special offers, promotions) and/or may encompass personal or professional benefits, including, but not limited to, employment or work opportunities. A non-limiting set of example opportunities includes, but is not limited to: promotional giveaways, employment opportunities, educational opportunities, lending or banking opportunities, and utility services. To apply for an opportunity, a person (e.g., a user, a client, a customer) provides applicant information. As used herein, an “application” refers to one or more application forms (e.g., online fillable forms, digital forms, physical form documents) having application information fields that are filled with corresponding applicant information of a person applying for an opportunity. As used herein, “applicant information” includes any information related to the person that is relevant to applying for the opportunity. A non-limiting set of example applicant information includes, but is not limited to: birth date, age, gender, address, employment status, educational history, purchase history, and social media account information.

Present embodiments are directed to a chatbot system that enables users to apply for opportunities via a chat interface. For example, a chatbot hosted by the chatbot system can receive a message (e.g., a natural language request) from a user and determine that the intent of the user message is to apply for a particular opportunity, such as a credit card, a job, or a utility service. In response, the chatbot may collect applicant information from various sources to enable the user to apply for the opportunity. In certain embodiments, the chatbot may receive images of documents supplied by the user via the chat interface and may extract applicant information from these document images. In certain embodiments, the chatbot may access a social media account of the user to extract applicant information. If applicant information to apply for the opportunity cannot be extracted from other sources, the chatbot may prompt the user to provide this addition information via the chat interface. In certain embodiments, the chatbot system enables the user to simultaneously apply for multiple opportunities and/or to apply for opportunities on external services. As such, the disclosed chatbot system enhances the user experience by enabling the application process to proceed via natural language messages and prompts, reducing the amount of applicant information that is provided directly by the user, reducing the number of mistakes in the application process, and maximizing the benefit to the user by enabling the application to multiple or different opportunities with minimal additional effort.

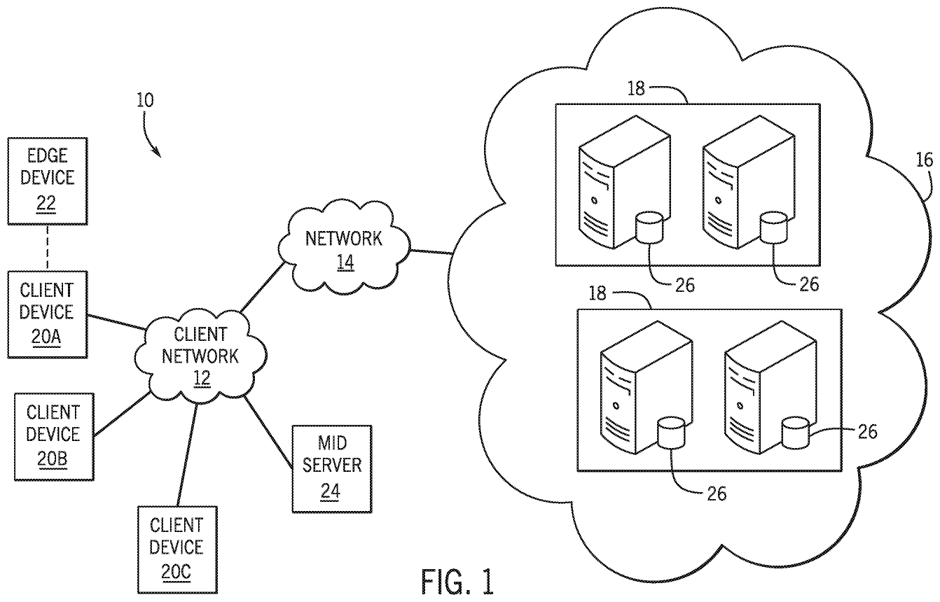

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

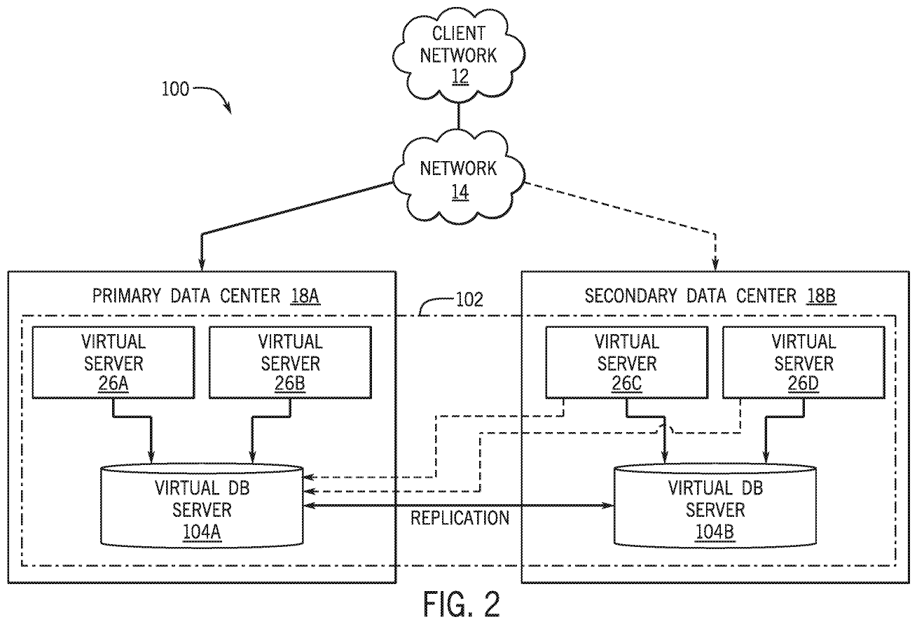

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

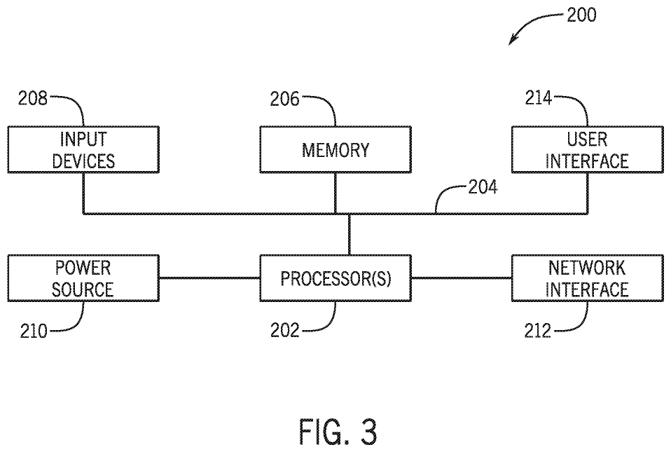

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

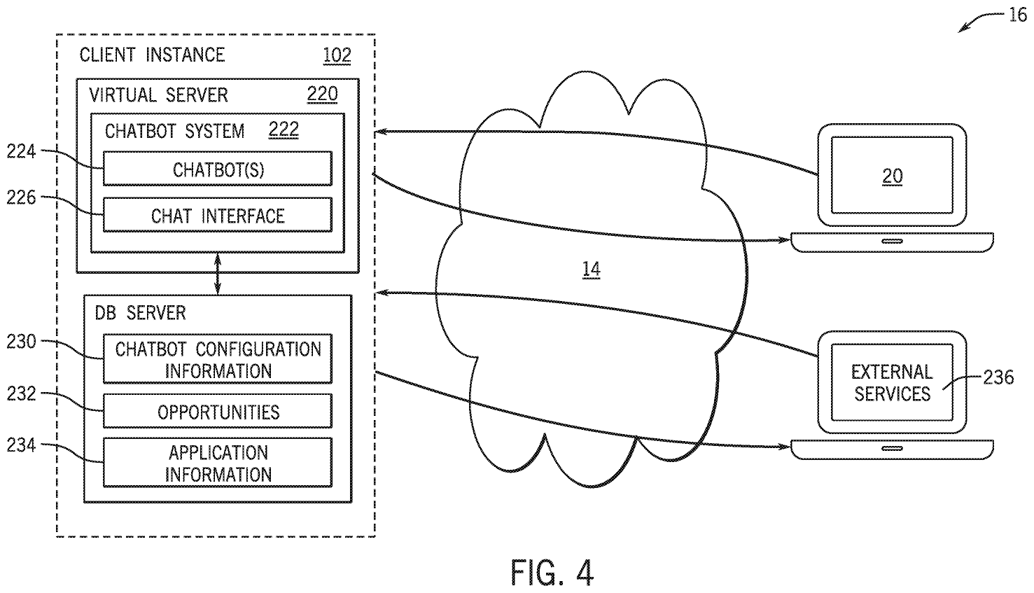

With the preceding in mind, FIG. 4 is a block diagram illustrating an embodiment in which a virtual server 220 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

More specifically, the illustrated virtual server 220 hosts a chatbot system 222, which enables the creation and deployment of one or more chatbots 224. Additionally, the illustrated chatbot system 222 is configured to host one or more chatbots 224, including chatbots that are designed to enable a user of the client device 20 to apply for an opportunity. In particular, the chatbot system 222 is designed to support and enable a chat interface 226 that is presented to users of the client devices 20. Using the chat interface 226, a user (e.g., a user of the client device 20) can provide a natural language request to apply for the opportunity. In response, the chatbot system 222 is configured to determine what applicant information is involved in applying for the opportunity. The chatbot system 222 is further designed to receive applicant information from the client device 20 of the user in a number of ways to facilitate the application process. For example, in certain embodiments, the chatbot system 222 is configured to receive images (e.g., digital photographs, scanned images) of documents (e.g., identification, diplomas, utility bills, tax documents, pay check stubs) of the user via the chat interface 226, and to extract applicant information to apply for the opportunity from these documents. Additionally or alternatively, in certain embodiments, the chatbot system 222 is configured to extract applicant information to apply for the opportunity from one or more social media accounts of the user. In certain embodiments, once suitable applicant information has been collected from the user, the chatbot system 222 may enable the user to simultaneously apply for multiple opportunities without the user providing additional applicant information. As such, the disclosed chatbot system 222 provides a natural language communication interface that leverages user information from various sources to improve the process of applying for opportunities by reducing time and effort on the part of the user, reducing data entry errors during the application process, and enabling the user to simultaneously apply for multiple opportunities to maximize the potential benefit to the user.

As shown in FIG. 4, the chatbot system 222 is communicatively coupled to a database (DB) server 228 of the client instance 102. The DB server 228 may store a collection of data that supports and enables the systems and methods discussed herein. For the illustrated embodiment, the DB server 228 stores chatbot configuration information table 230 that, as discussed below, defines the properties and behavior of the chatbots 224 of the chatbot system 222. In certain embodiments, the DB server 228 includes an opportunities table 232 that stores opportunities for which a user may apply via the chat interface 226. For example, the opportunities table 232 may define which applicant information (e.g., name, age, date of birth, employment status, educational history, social media information) is to be provided by a user to apply for a particular opportunity. In certain embodiments, the DB server 228 may include an applicant information table 234 that stores applicant information received from a user that is applying for an opportunity via the chat interface 226.

The illustrated embodiment of the chatbot system 222 is communicatively coupled to any suitable number of external services 236, and to any suitable number of client devices 20, via the network 14. In some embodiments, the external services 236 are implemented using any suitable type of system, such as one or more servers and/or other computing devices. For embodiments in which the chatbot system 222 extracts applicant information from a social media account, the external services 236 include any suitable social media services (e.g., FACEBOOK®, SLACK®, LINKEDIN®). For example, in certain embodiments, a profile of a user on a social media service (e.g., LINKEDIN®) may include a digital resume having the educational history and/or employment history of the user, as well as various professional relationships and recommendations, all of which can be collected as applicant information. In some embodiments, the external services 236 may include other services (e.g., employment location services, businesses, lending or banking services, utility server) that offer other opportunities (e.g., for employment, prizes, credit, or service) for which the user of the client device 20 can apply via the chat interface 226. In some embodiments, the user of the client device 20 may communicate with other users of other client devices or with any of the external services 236 via the chat interface 226 provided by the chatbot system 222.

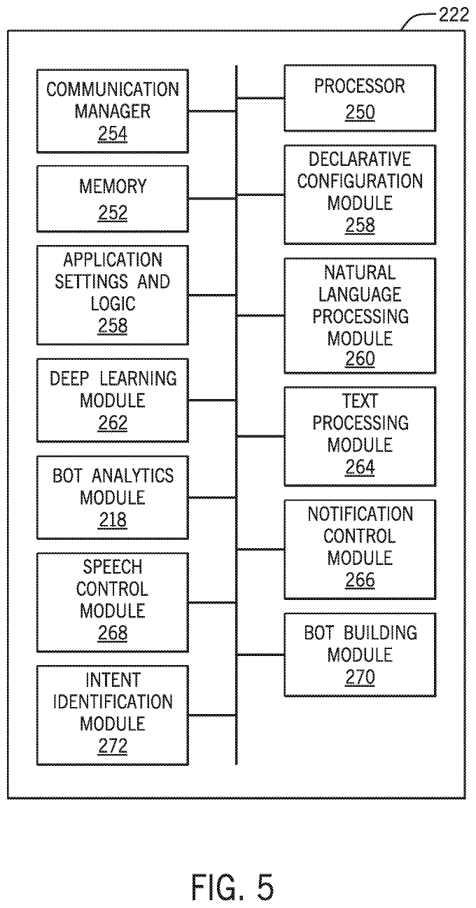

FIG. 5 is a block diagram depicting an embodiment of the chatbot system 222. As shown in FIG. 5, the chatbot system 222 includes a processor 250 and a memory 252, which may correspond to one or more processors or memories of the data center hosting the client instance 102. The processor 250 executes various instructions to implement the functionality provided by chatbot system 222, as discussed herein. The memory 252 stores these instructions, as well as other data used by processor 250 and other modules and components contained in the chatbot system 222.

The illustrated chatbot system 222 includes a communication manager 254 that enables the system to communicate with other systems, such as external services 236, the DB server 228, client devices 20, and the like. The illustrated chatbot system 222 also includes a declarative configuration module 256 that allows a customer, user, or other person or system to set configuration values in the chatbot configuration information table 230 associated with the chatbots 224, as discussed herein. The application settings and logic 258 provide various settings, rules, and other logic functions, as discussed herein. A natural language processing module 260 performs various natural language processing tasks, as discussed herein. A deep learning module 262 performs various deep learning functions to implement the systems and methods discussed herein. A text processing module 264 performs various text processing tasks, such as processing text in a received message and processing text in a response to a received message.

The chatbot system 222 illustrated in FIG. 5 further includes a notification control module 266 that controls various messages and notifications, as described herein. A speech control module 268 manages various speech data, such as speech data associated with received voice messages and speech data associated with responses generated by the systems and methods discussed herein. A bot building module 270 enables a user or system to create a bot to perform one or more specified tasks. An intent identification module 272 determines an intent associated with, for example, a received message.

The chatbot system 222 shown in FIG. 5 represents one embodiment. In alternate embodiments, any one or more of the components shown in FIG. 5 may be implemented in a different system, device or component. For example, the components associated with creating and training aspects of the chatbots 224 may be provided in one system (e.g., a chatbot training system or chatbot creation system), and the components associated with managing and/or implementing particular chatbots may be provided in one or more other systems (e.g., a bot management system or a bot implementation system).

The systems and methods discussed herein provide a conversational interface that includes an ability to interact with a user of a computing system (e.g., a user of the client device 20) using natural language and in a conversational way. The systems and methods described herein enable the chatbot system 222 to understand natural language, interpreting what the user means in terms of intent, and extracting information to generate a response back to the user and/or to apply for an opportunity. Intent identification is a part of natural language understanding that involves determining an intent from a natural language message (e.g., utterance, statement, request) of a user. Entity and attribute extraction includes extracting various useful information, such as subjects and objects, from the natural language message. In some embodiments, customized notifications enable the chatbot system 222 to send notifications to a user on a particular messaging platform with custom intent responses. Additionally, the systems and methods described herein keep track of useful and contextual information across user messages. For example, the chatbot system 222 may receive a first message from the client device 20 via the chat interface 226 in which the user requests to apply for an opportunity, and subsequently receive other messages from the user providing applicant information to apply for the opportunity. The chatbot system 222 provides a mechanism to keep track of useful information and context across multiple messages. Additionally, the chatbot system 222 supports sequence learning and auto-replies. For example, the chatbot system 222 can learn from a sequence of interactions and automatically reply to certain messages based on past interactions.

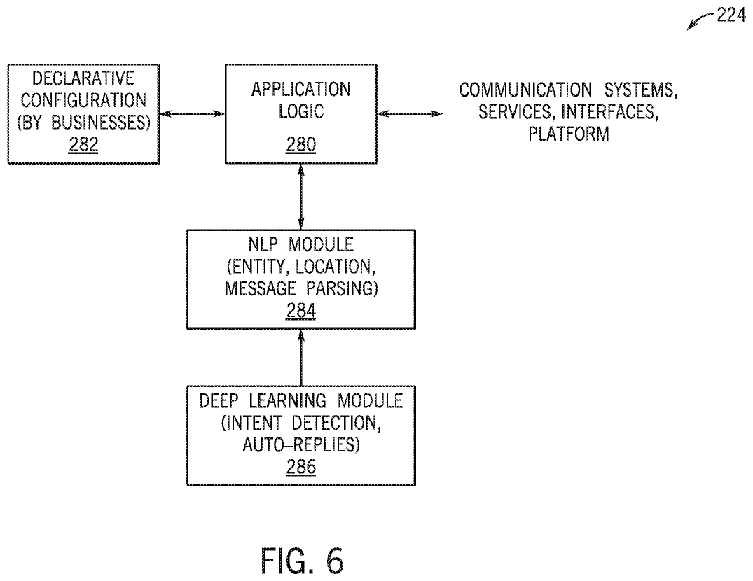

FIG. 6 is a block diagram depicting an embodiment of the chatbot 224 of the chatbot system 222, which responds to user messages (e.g., natural language requests) received from the client device 20 via the chat interface 226. The illustrated embodiment of the chatbot 224 includes application logic 280 that is designed to receive any number of messages (also referred to herein as requests) from a remote system, such as the client device 20 and/or one or more external services 236 (e.g., communication services, messaging services). In some embodiments, the requests may be received via external services 236 (e.g., FACEBOOK® Messenger, SLACK®, SKYPE®). In different embodiments, a message may include a text message, a voice (e.g., audio) message, images, hyperlinks, and the like. The application logic 280 of the chatbot 224 performs various tasks based on the type of request received, the content of the received request, and other factors. For example, application logic 280 may be configured based on a declarative configuration 282, which may be stored in the chatbot configuration information table 230 or another suitable data source. This declarative configuration 282 may be defined by a business, a customer, or other person or entity associated with operation of a chatbot 224 and/or the chatbot system 222. For example, declarative configuration 282 may define how the chatbot 224 will respond to a particular message based on the identified intent in the request or message.

For the embodiment illustrated in FIG. 6, the application logic 280 is communicatively coupled to a Natural Language Processing (NLP) module 284, which performs various tasks, such as entity determination, location identification, message parsing, and the like. The illustrated NLP module 284 may also provide intent information (e.g., an intent that can be determined or inferred from the content of the received natural language message) to application logic 280 for use in responding or otherwise processing the received request. In some embodiments, the intent information is maintained in a deep learning module 286 that provides information regarding intent and other information to assist in responding to the request. The information provided by deep learning module 286 is based on machine learning and analysis of multiple requests and ground truth information associated with those multiple requests. After the application logic 280 receives the intent information from the NLP module 284, the application logic 280 uses the intent information along with the information in declarative configuration 282 to generate a response to the request. For example, the response may be a simple text response (e.g., “hello”), an application programming interface (API) call to another data source to retrieve data necessary for the response, and the like.

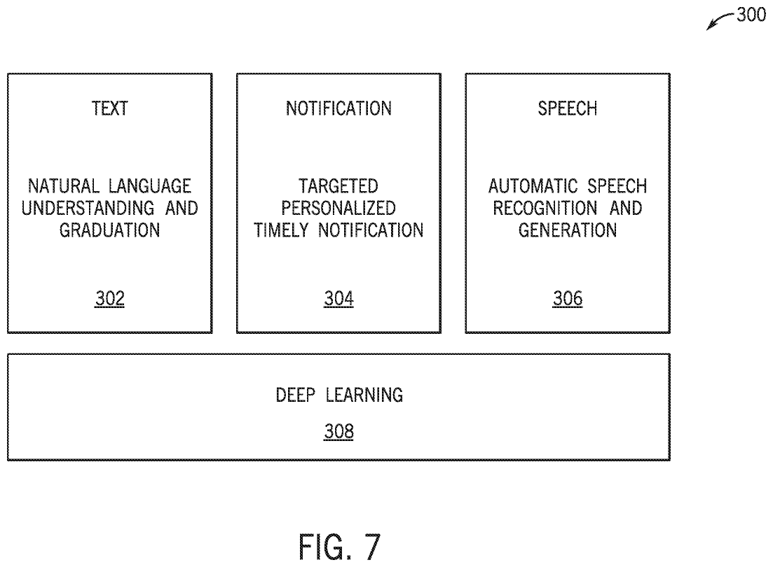

FIG. 7 is a block diagram depicting an embodiment of a framework 300 that supports conversational artificial intelligence within the chatbot system 222, as described herein. In the framework 300 of FIG. 7, a text portion 302 of the framework provides natural language understanding and generation. A notification portion 304 of the framework provides different types of notifications in a targeted, personalized, and timely manner. A speech portion 306 of the framework performs various tasks associated with automatic speech recognition and generation. A deep learning portion 308 of the framework performs various deep learning and machine learning functions to implement the systems and methods discussed herein.

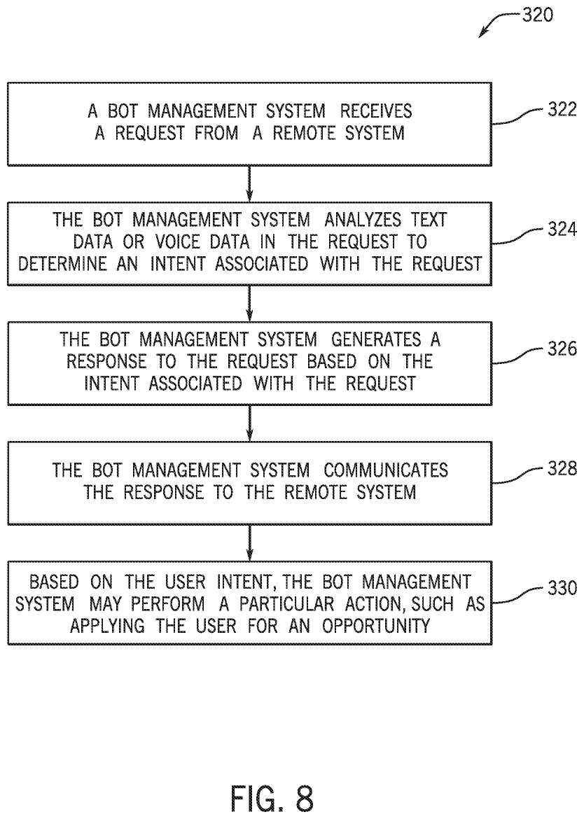

FIG. 8 is a flow diagram depicting an embodiment of a process 320 whereby the chatbot system 222 responds to messages received from a remote system (e.g., client device 20, external services 236). Initially, the chatbot system receives (block 322) a request (e.g., a natural language message) from a remote system via the chat interface 226. The chatbot system analyzes (block 324) the text data or voice data in the request to determine an intent associated with the request. Based on the determined intent, the chatbot system generates (block 326) a response to the request. In some embodiments, the generated response may also include declarative configuration information, or any other data, as discussed herein. The chatbot system 222 then communicates (block 328) the response to the remote system. In some embodiments, based on the user intent, the chatbot system may perform (block 330) a particular action or activity, such as applying for an opportunity or determining whether or not a user qualifies for an opportunity. In some embodiments, this particular action or activity may be performed instead of generating a response or in addition to generating a response.

In certain implementations, intents form the basic building blocks of the chatbots 224 hosted by the chatbot system 222. Within the chatbot configuration information table 230 of the chatbot system 222, each chatbot 224 has at least one intent defined. In some embodiments, certain intents (e.g., entry intents) include one or more intent phrases, which are a set of utterances/phrases that enables the intent identification engine to identify the intent when it appears within a received message. In some embodiments, certain intents (e.g., follow-on/conversational intents) may not include intent phases, and may instead be invoked based on the overall context of a conversation.

In some embodiments, each intent includes one or more actions to be performed in response to the intent being identified within a received message. In some embodiments, at least a portion of the actions associated with certain intents may be defined by a decision tree (e.g., a multi-level decision tree) associated with the intent. These decision tree may include, for example, data-driven decision trees that are automatically created based on data stored by the DB server 228, as well as configuration-driven decision trees that enable chatbot designers to create customized decision nodes. These decision trees may support conditional branch logic based on input data or data from the DB server 228 (e.g., including both contextual and non-contextual data). In some embodiments, a decision tree (e.g., a decision tree associated with an “apply to opportunity” intent) may include slot-filling nodes, each designed to receive a particular piece of applicant information for a user to apply for a particular opportunity. As discussed below, the decision tree of an intent may also include one or more nodes configured to provide a prompt to the user via the chat interface 226, to receive images of documents or receive access to social media accounts, and to extract applicant information from these sources to populate one or more slot filling nodes of the decision tree.

For example, in certain embodiments, an intent of a chatbot 224 hosted by the chatbot system 222 may include a data-driven decision tree. The data-driven decision trees offers enable configuration and updates to decision trees to happen dynamically as the data changes (e.g., as the relevant applicant information to apply for an opportunity changes). For example, suitable data can be provided as a file, in tabular format (e.g., comma-separated values (CSV)) or hierarchical format (e.g., JavaScript Object Notation (JSON)). Once this data is provided to the chatbot 224, the creator can configure an intent to trigger a decision tree. Using the data, the decision tree will guide the user through a conversation to find a set of results or an exact match for which the chatbot creator can define an appropriate action once the user reaches a leaf node in the decision tree. When this data changes, the chatbot behavior will automatically update in real-time.

In certain embodiments, one or more nodes of a decision tree may be configured to utilize one or more webhooks that are defined for the intent. When triggered by the detection of the corresponding intent or by a node of a decision tree of the corresponding intent, these webhooks enable the chatbot system 222 to exchange data with the one or more external services 236. These webhooks enable the chatbot 224 to fetch data from a remote API server, database, or by scraping a website hosted by the external services 236. In some embodiments, an intent of a chatbot 224 may include any suitable number of webhooks. In certain embodiments, a webhook may define one or more of: a data source, pre- and/or post-processing functions, and data extraction functions. The data source may define the identity, location (e.g., internet protocol (IP) address, uniform resource locator (URL), port information), authentication/authorization parameters, table names, and request parameters (e.g., based on the context). The pre- and/or post-processing functions handle data conversion between different file formats (e.g., CSV, JSON, extensible markup language (XML), Hypertext Markup Language (HTML)), while the data extraction functions extract data in a desired format for use by the chatbot system 222 and mapped to a decision tree of the intent (e.g., to satisfy one or more slot filling nodes of the decision tree).

The described systems and methods support intent identification and configuration in chatbots. In some embodiments, the chatbot system 222 maintains a data store (e.g., in the chatbot configuration information table 230) where the set of all possible intents associated with each chatbot 224 is stored. In certain embodiments, for each intent, the chatbot system 222 stores a set of keyphrases that match this intent. For example, a “greetings” intent may have keyphrases such as “hi”, “hello”, “hola”, etc. Any changes in intent keyphrases are propagated throughout the system for intent identification. In some situations, each intent keyphrase has a priority label, such as high or low. Low priority labels are designed for common words such as “hi”, which may capture the full intention of a message. In some embodiments, a set of rules may be applied to perform text-based intent matching. For example, these rules may rely on string matching (e.g., regular expressions) of intent keyphrases within a received natural language message. For each input message, the chatbot system 222 analyzes the text and returns a set of matches.

In certain embodiments, intent matching may include a number of step. For example, in some embodiments, an intent matching process may begin with the chatbot system 222 obtaining from the chatbot configuration information table 230, or another suitable data source, a list of all keyphrases associated with each intent. If one or more keyphrases match the input message, then the matching intent will be added to the result. In certain embodiments, this step may be repeated while the chatbot system 222 applies text stemming (e.g., text expansion/modification) to both the input message and the intent keyphrases. Then, for each matched intent, if the matching keyphrases only have low priority labels, then the match may also be considered a low priority match. Additionally, the chatbot system 222 may compute the ratio between the length of the matching keyphrases and the length of the message, as a proxy score. If this ratio is higher than a predefined threshold for a particular match, then the chatbot system 222 can be reasonably confident that is a good quality match. If there is no match, or all matches are low priority, or all matches are lower than the threshold, then the chatbot system 222 may progress to intent classification, as described below.

It is presently recognized that string matching rules can be limited, given the richness of natural languages, and there exist many different ways for people to express a certain intention. Thus, if text matching does not yield any result (or only low priority results), the chatbot system 222 may invoke a method of intent classification using a machine learning system (also referred to as a machine learning model). In some embodiments, the machine learning model includes one or more deep neural networks. As discussed below, particular implementations use a Long Short-Term Memory (LSTM) technique.

As may be appreciated, the machine learning system is first trained and then can be used to predict intent of an incoming natural language message. Regardless of whether training or prediction is occurring, the chatbot system may apply one or more text pre-processing steps on training messages and user messages received for intent prediction. In certain embodiments, pre-processing may include removing stop words (e.g., “a”, “the”, “this”, “that”, “I”, “we”), which are commonly used English words that are not meaningful enough to yield relevance. Pre-processing may include removal of non-alphanumeric characters from the message, which typically do not have strong linguistic values either. Each of the words of the message are converted into a vector representation, such as a 300-dimensional dense vector with floating values, using word2vec or another suitable word embedding tool. In certain embodiments, the vector representations may be normalized. For example, in some cases, the vector representations are normalized by their L2-norm, and hence, mathematically all the vectors are of norm-1.

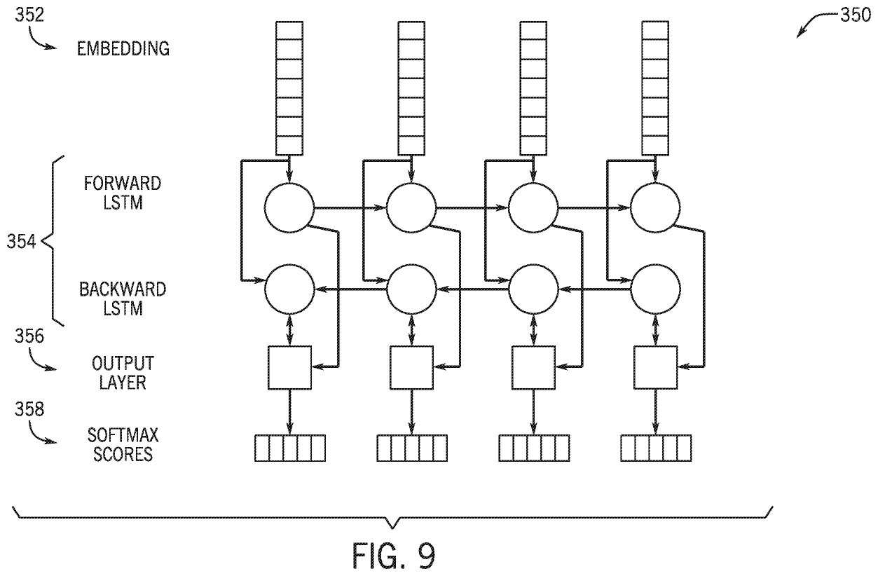

FIG. 9 is a block diagram of an embodiment of a Recurrent Neural Network (RNN) 350 having a Long Short-Term Memory (LSTM) architecture, which is an example of a machine leaning (or deep learning) system that the chatbot system 222 may train and use for intent classification. The RNN 350 differs from other neural network architectures in that the output of each cell is again fed into itself for the next learning step. The LSTM architecture is a more complicated form of RNN, which adds additional mathematical transformations of certain cells to capture long-term dependencies between cells and layers. The RNN 350 with LSTM provides strong capability to understand natural language, because it is able to extract and memorize context signals of the input text, which is similar to how human beings process language.

As shown in FIG. 9, for the illustrated RNN 350, a first layer is the embedding layer 352, which maps each word in the user message to a large dimensional vector using. The illustrated embedding layer 352 may be separately trained using techniques like word2vec or another suitable word embedding tool. The second layer includes a forward and backward long short term memory network (LSTM) 354, which generally operates a state machine that parses the user message one word at a time. The state is highly distributed as a high-dimensional vector and can “learn” from and/or predict on several latent features from a message. At each step in the operation of this LSTM 354, the input includes the next word from the message being processed and the previous state of the state machine. The output is the new distributed value or high-dimensional vector for the state. Each processing step or iteration of the LSTM 354 can be likened to parsing each word of a message in the context of its neighboring words. The final state of the LSTM 354 is a vector representation of the entire user message, which can be used for downstream tasks like intent classification. Unlike word vectors, which may be computed independent of the user message, the output of the LSTM 354 is highly dependent on both the words of the message and their relative positions. Additionally, it is presently recognized that using a bidirectional LSTM 354 enables all words of the message to have equal influence in the final state, as opposed to giving undue influence to the words in the later part of the message. The third layer of the illustrated embodiment is an output layer 356, which is a dense one-layer neural network connecting the output of the second layer (the vector representation of the user message), with a softmax layer 358 that computes probabilities over all intent classes. In certain embodiments, the RNN 350 uses dropout at the recurrent layer of the LSTM 354 and the output layer 356.

During a training phase, training data is provided to the RNN 350 to enable the RNN 350 to recognize predefined patterns in received user messages. The RNN 350 learns to recognize these patterns via a mathematical optimization procedure. In some embodiments, the training data comes from customer service logs or other applicable conversation logs. Each data point consists of the text content (what was said) and a ground-truth label (what is the true intent). Typically, the labeling process is conducted manually to create the training data. The output layer 356 of the RNN 350 consists of N cells, where N is the number of intents (e.g., classes) defined for a chatbot 224. In some embodiments, to learn the parameters in the network (e.g., the weight on each link in the neural network), the system uses the stochastic gradient descent method. In some embodiments, to avoid overfitting, the system uses the dropout method, which probabilistically remove links between two layers of the RNN 350, to avoid the RNN 350 from becoming too biased toward the training samples.

After training is complete, the RNN 350 can be used for intent prediction. For a received user message, the chatbot system 222 first performs pre-processing, as discussed above. The chatbot system 222 sends the word vectors into the trained RNN 350 (e.g., the RNN 350 model built during the training phase). For each received message, the RNN 350 outputs a respective score (e.g., between 0 and 1) to each intent defined for the chatbot 224. These scores may be normalized, such that the scores sum to 1 and represent probabilities. The highest score is associated with the most likely intent, according to the RNN 350. The system outputs this intent and the score to the front-end of the system, which may then perform actions related to the most probable intents.

Beyond intents, it is appreciated that entities and attributes can include information that is important to understanding a user message. For example, “looking for a green dress” means that the customer is essentially issuing a product search query with respect to green dresses. Here, “dress” is an entity (e.g., a product) and “green” is an attribute (e.g., a color). For each chatbot 224, the system has a predefined set of relevant entities and relevant attributes (e.g., stored in the chatbot configuration information table 230). In certain embodiments, the chatbot system 222 may implement entity and attribute extraction, which involves retrieving the predefined set of relevant entities and attributes defined for a chatbot 224, and then performing string matching to locate these relevant entities and attributes within a user message received by the chatbot 224. In some situations, an entity in a user message includes multiple associated entities that are explicitly or implicitly provided. For instance, consider a message specifying “Mountain View, Calif.” as a location. Here, not only “Mountain View” and “CA” can be extracted as the city name and state code, respectively, but the chatbot system 222 can also determine the associated zip code (e.g., via a look-up table stored by the DB server 228, via a webhook).

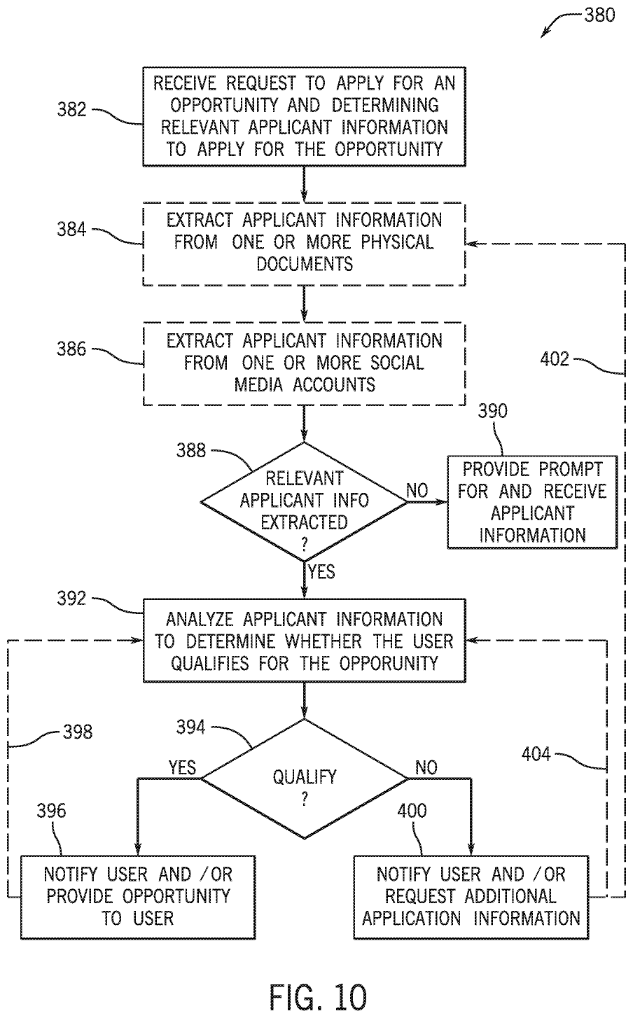

FIG. 10 is a flow diagram of an embodiment of a process 380 whereby the chatbot system 222 enables a user (e.g., a user of the client device 20) to apply for an opportunity via the chat interface 226 of the chatbot system 222. In other words, via the process 380, the chatbot system 222 collects applicant information of a user from a number of different sources, and then uses this application information to complete an application (e.g., an online application or application process) to apply for an opportunity on behalf of the user. The process 380 may be stored in a suitable memory (e.g., memory 206) and executed by a suitable processor (e.g., processor 202) associated with the client instance 102. In other embodiments, the process 380 may include omitted steps, repeated steps, or additional steps, relative to the embodiment of the process 380 illustrated in FIG. 10. The process 380 of FIG. 10 is discussed with reference to elements illustrated in FIG. 4. Additionally, while the process 380 is discussed with respect to applying for a single opportunity at one time for simplicity, in other embodiments, the process 380 can enable the user to simultaneously apply for multiple opportunities simultaneously without departing from the present technique.

The process 380 illustrated in FIG. 10 begins with the chatbot system 222 receiving (block 382) a request to apply for an opportunity and determining the applicant information that is involved in completing the application for the opportunity (e.g., the applicant information fields of the application). For example, the chatbot system 222 may receive a natural language message from the user of the client device 20 requesting to apply for the opportunity. For example, a received natural language request may specify, “I would like to apply for the human resources director position” or “Can I enter to win the December prize give-away?” or “How do I apply for an auto loan?” or “I want to sign up for electrical utility services.” The chatbot system 222 receives and processes the received message, and determines that the user's intent is to apply for a particular opportunity. The determined intent (e.g., an “apply to” intent) may be associated with a corresponding decision tree in the chatbot configuration information table 230 stored by the DB server 228. In certain embodiments, the decision tree may include nodes (e.g., slot filling nodes) that indicate different applicant information fields or slots, along with prompts for the user to provide the corresponding applicant information for each of these fields via the chat interface 226. In certain embodiments, the chatbot system 222 may retrieve a list of applicant information fields to apply for the requested opportunity from the opportunities table 232 or another suitable data source.

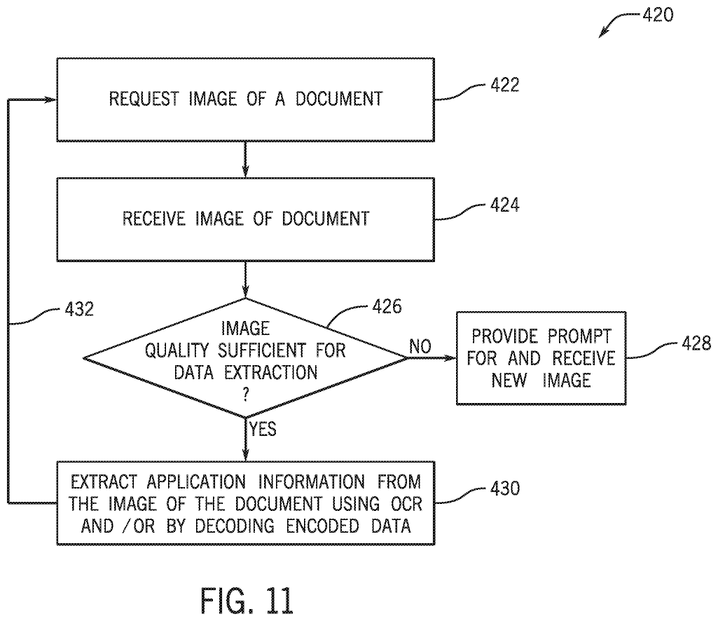

The process 380 illustrated in FIG. 10 continues with the chatbot system 222 extracting (block 384) application information from one or more physical documents of the user. As discussed in detail below with respect to FIG. 11, the chatbot system 222 can request and receive images of documents of the user, and then analyze these documents to extract relevant applicant information to fill corresponding applicant information fields and apply for the opportunity. For example, the actions of block 384 may represent an initial or early node in the decision tree associated with an identified “apply to an opportunity” intent. This initial node may be configured to cause the chatbot system 222 to prompt the user for images of documents, to analyze the documents to extract relevant applicant information, and then to use this extracted application information to satisfy one or more slot filling nodes of the decision tree. In certain embodiments, the actions of block 384 may be skipped.

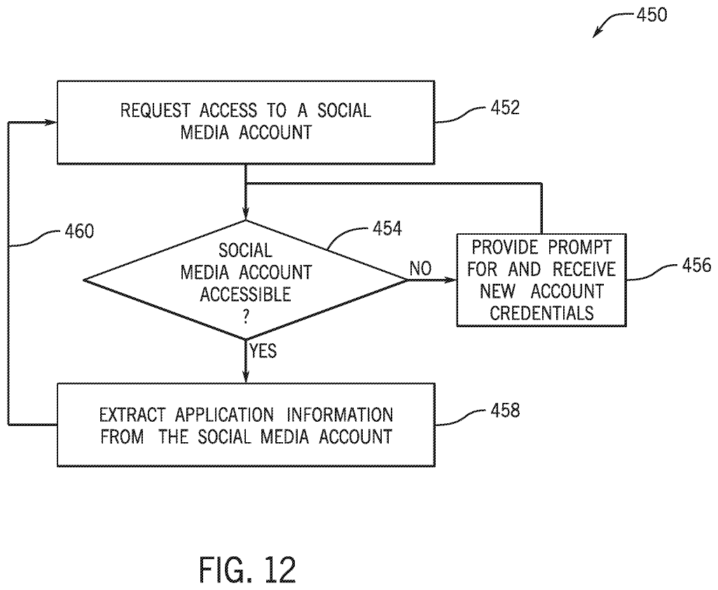

The process 380 illustrated in FIG. 10 continues with the chatbot system 222 extracting (block 386) application information from one or more social media accounts of the user. As discussed in detail below with respect to FIG. 12, the chatbot system 222 can gain access to information associated with the social media account of the user to extract desired applicant information to fill corresponding applicant information fields and apply for the opportunity. For example, the actions of block 386 may represent an initial or early node in the decision tree associated with an identified “apply to an opportunity” intent. This initial node may be configured to cause the chatbot system 222 to prompt the user for credentials or permission, to analyze the information associated with the social media account to extract relevant applicant information, and then to use this extracted application information to satisfy one or more slot filling nodes of the decision tree. In certain embodiments, the actions of block 386 may be skipped. In some embodiments, either the actions of block 384 or the actions of block 386 are performed, while in other embodiments, the actions of block 384 and block 386 are both performed within the process 380.

The process 380 illustrated in FIG. 10 continues with the chatbot system 222 determining whether (decision block 388) the all of the relevant pieces of applicant information for the applicant information fields of the application for the opportunity have been extracted in blocks 384 and/or 386. For example, the chatbot system 222 may analyze the decision tree associated with the “apply to an opportunity” intent to determine if there are slot filling nodes that have not yet been satisfied. If one or more pieces of applicant information fields have not been satisfied with provided or extracted applicant information, then the chatbot system 222 may provide (block 390), via the chat interface 226, a prompt to the user of the client device 20 to provide a missing piece of applicant information, and then receive the prompted applicant information from the client device 20. For example, the chatbot system 222 may locate the first slot filling node of the decision tree that has not been satisfied, use the prompt associated with the node to request the applicant data from the user of the client device 20, receive the requested information from the user, and fill the node with the received data. Then, chatbot system 222 returns to decision block 388 and repeats the actions of block 390 until all of the relevant applicant information for the user to apply for the opportunity has been received or extracted (e.g., all slot filling nodes of the decision tree have been filled or satisfied).

The process 380 illustrated in FIG. 10 continues with the chatbot system 222 analyzing (block 392) the received and extracted applicant information to determine whether the user qualifies for the opportunity. For example, the opportunity may be limited to a select group of users having certain qualifications that can be evaluated automatically based on the applicant information. In certain embodiments, the chatbot system 222 may determine, based on the applicant information, whether the user meets the criteria defined in the opportunities table 232 to qualify for the opportunity. In certain embodiments, at least a portion of this criteria may be defined as desired values (e.g., the user should have an address in a particular city to qualify for an opportunity) or as threshold values (e.g., the user should have an income greater than a predetermined threshold value to qualify for an opportunity), and these values may be stored in the opportunities table 232 or another suitable data source. In certain examples, such as a prize giveaway, other relevant information may be considered in addition to the applicant information, such as a number of prizes remaining to be given away (e.g., determined from a count stored in the opportunities table 232 or another suitable data source). In other embodiments, the chatbot system 222 may not immediately determine whether the user qualifies for the opportunity (e.g., for opportunities that involve human review to access qualifications), and for such embodiments, at block 395, the chatbot system 222 may instead submit an application for the user to apply for the opportunity having its fields populated with the applicant information, and then notify the user that the application has been submitted via the chat interface 226.

For the illustrated embodiment, when (decision block 394) the chatbot system 222 determines that the user does qualify for the opportunity, the system may notify (block 396) the user, via the chat interface 226, that the user qualifies for the opportunity. In certain embodiments, the chatbot system 222 may provide the information relating to accepting or using the opportunity directly to the user of the client device 20 via the chat interface 226. For example, for a digital gift card giveaway, the chatbot system 222 may provide the user with the digital gift card information via the chat interface 226. Since certain chat interfaces also enable the transfer of currency, in certain embodiments, the chatbot system 222 may transfer funds associated with the opportunity to an account of the user. In some embodiments, the chatbot system 222 may send the user a message, via the chat interface 226, indicating that, in addition to the user qualifying for the requested opportunity, the user may also qualify for other opportunities (e.g., stored in the opportunities table 232), and prompt the user to decide whether or not to apply for those opportunities. In response to receiving an indication, via the chat interface 226, that the user wants to apply for the additional opportunities using the previously collected applicant information, the chatbot 224 may return to block 392 to determine whether the user qualifies for the additional opportunities, as indicated by dashed arrow 398.

For the illustrated embodiment, when (decision block 394) the chatbot system 222 determines that the user does not qualify for the opportunity, the system may notify (block 400) the user, via the chat interface 226, that the user does not presently qualify for the opportunity. In certain embodiments, the chatbot system 222 may determine whether the opportunity defines any secondary considerations that may enable the user to qualify for the opportunity. For example, the chatbot system 222 may send the user a message, via the chat interface 226, indicating that, while the user does not presently qualify based on the applicant information provided thus far, the user may still qualify if additional applicant information is provided that satisfies other values and thresholds defined for the opportunity. In response to receiving and indication, via the chat interface 226, that the user wishes to provide additional applicant information, the chatbot 224 may return to block 384 to collect the additional applicant information, as indicated by dashed arrow 402. In some embodiments, at block 400, the chatbot system 222 may send the user a message, via the chat interface 226, indicating that, while the user does not qualify for the initially-requested opportunity, the user may qualify for other opportunities (e.g., stored in the opportunities table 232), and prompt the user to decide whether or not to apply for those opportunities using the previously collected applicant information. In response to receiving an indication, via the chat interface 226, that the user wishes to apply for the other opportunities using the previously collected applicant information, the chatbot 224 may return to block 392 to determine whether the user qualifies for the other opportunities, as indicated by dashed arrow 404.

It may be appreciated that, in certain embodiments, the chatbot system 222 can also enable the user of the client device 20 to apply for opportunities, via the chat interface 226, that are offered by external services 236. For such embodiments, at block 382, the chatbot system 222 may determine which applicant information is involved for the user to apply to the opportunity by requesting and receiving opportunity information from the external service 236. For example, an “apply to external offer” intent may have corresponding webhooks, including a webhook configured to retrieve applicant information fields for an application to apply for the opportunity offered by the external service 236. For such embodiments, once the relevant applicant information has been collected (e.g., in blocks 384, 386, and/or 390), at block 392, the chatbot system 222 may instead use another webhook of the “apply to external offer” intent to send the collected applicant information to the external service 236 (e.g., submit an application for the opportunity that has been populated with the applicant information) to determine whether or not the user qualifies, and may notify the user of the results received from the external service 236. As noted above, in some embodiments, the process 380 can enable the user to simultaneously apply for multiple opportunities (e.g., offered one or from multiple external services) without departing from the spirit of the present technique.

FIG. 11 is a flow diagram of an embodiment of a process 420 whereby the chatbot system 222 receives and processes an image of a document of the user to extract applicant information to apply for an opportunity. As such, the process 420 of FIG. 11 corresponds to block 384 in the process 380 of FIG. 10. The process 420 may be stored in a suitable memory (e.g., memory 206) and executed by a suitable processor (e.g., processor 202) associated with the client instance 102. In other embodiments, the process 420 may include omitted steps, repeated steps, or additional steps, relative to the embodiment of the process 420 illustrated in FIG. 11. The process 420 of FIG. 11 is discussed with reference to elements illustrated in FIG. 4, as well as the process 380 of FIG. 10.

The embodiment of the process 420 illustrated in FIG. 11 begins with the chatbot system 222 requesting (block 422), via the chat interface 226, that the user provide an image of a particular document. The requested document may be a document that is known or suspected to include at least one piece of applicant information. A non-limiting list of example documents includes: driver's license, passport, birth certificate, utility bills, diplomas, educational transcripts, financial statements, pay stubs, and tax documents. For example, when the chatbot system 222 is traversing a decision tree associated with an intent to apply for a particular opportunity (e.g., a credit account), then the corresponding decision tree may include a node having a prompt for the user to provide an image of their driver's license, and may also include a number of slot filling nodes that expect to receive particular pieces of applicant information, including information that can potentially be extracted from the image of the driver's license.

The process 420 illustrated in FIG. 11 continues with the chatbot system 222 receiving (block 424), via the chat interface 226, the image of the requested document. The chatbot system 222 may receive a photograph of the requested document or a scanned image of the requested document. In certain embodiments, the chatbot system 222 may receive an image that includes encoded data. For example, the chatbot system 222 may prompt the user and, in response, receive an image (e.g., a photograph) of a back side of a driver's license or a page of a passport that includes one or more pieces of applicant data encoded in the form of a barcode, a quick response (QR) code, or another suitable encoded element.

The process 420 illustrated in FIG. 11 continues with the chatbot system 222 determining (decision block 426) whether the image quality is sufficient for data extraction. In certain embodiments, the chatbot system 222 analyzes the image to determine whether the image meets or exceeds predefined criteria to be suitable for data extraction. For example, the chatbot system 222 may compare a brightness of the image to a threshold brightness to determine whether the lighting for a photograph was greater than a predefined threshold. The chatbot system 222 may consider any suitable number of aspects of the received image (e.g., brightness, color, clarity, contrast, saturation, noise) to determine whether the image is suitable for data extraction. When the chatbot system 222 determines that the image is unsuitable, the chatbot system 222 may provide a prompt (block 428), via the chat interface 226, to request that the user provide a different image of the document.

When the chatbot system 222 determines that the image has sufficient image quality, the process 420 continues with the chatbot system 222 extracting (block 430) applicant information from the image of the document using optical character recognition (OCR), by decoding one or more encoded data elements (e.g., barcodes, QR codes), or any combination thereof. That is, as discussed with respect to FIG. 10, the chatbot system 222 may first attempt to extract as much applicant information from the image of the document to fill as many slot filling nodes of the current decision tree associated with the “apply to opportunity” intent, and then may prompt the user to provide other applicant information that could not be gleaned from the image. In certain embodiments, the process 420 of FIG. 11 may be repeated, as indicated by the arrow 432, until all of the user documents have been provided to apply for the opportunity.

FIG. 12 is a flow diagram of an embodiment of a process 450 whereby the chatbot system 222 accesses a social media account of the user to extract applicant information. As such, the process 450 of FIG. 11 corresponds to block 386 in the process 380 of FIG. 10. The process 450 may be stored in a suitable memory (e.g., memory 206) and executed by a suitable processor (e.g., processor 202) associated with the client instance 102. In other embodiments, the process 450 may include omitted steps, repeated steps, or additional steps, relative to the embodiment of the process 450 illustrated in FIG. 12. The process 450 of FIG. 12 is discussed with reference to elements illustrated in FIG. 4 and the process 380 of FIG. 10.

The process 450 illustrated in FIG. 12 begins with the chatbot system 222 requesting (block 452), via the chat interface 226, access to a social media account of a user. For example, the chatbot system 222 may send a message to the user indicating that the chatbot system 222 requests access to a social media account hosted by an external service 236, and may prompt the user to respond by providing authentication credentials for the social media account. In certain embodiments, the chatbot system 222 and the client instance 102 may be hosted as part of a social media platform, in which case, the DB server 228 may store social media information related to the user, and authentication credentials may not be requested from the user.

The process 450 illustrated in FIG. 12 continues with the chatbot system 222 determining (decision block 454) whether or not the social media account information is accessible. For example, the chatbot system 222 may utilize a webhook associated with the “apply to opportunity” intent to access the social media account of the user from the external service 236. If the chatbot system 222 is unable to access the social media account or the associated applicant information, the chatbot system 222 may provide a prompt (block 456), via the chat interface 226, to receive new account credentials for the social media account.

When the chatbot system 222 is able to access the social media account of the user and the applicant information contained therein, the chatbot system 222 may extract (block 458) any applicant data that is relevant to applying to the opportunity. In certain embodiments, the chatbot system 222 may utilize a webhook associated with the “apply to opportunity” intent to access the social media account of the user from the external service 236 to request and receive the applicant information from the external service 236. For example, for an opportunity that specifies that the submitted applicant information should include a social graph of all of the people that are linked to (e.g., friends with) the user, the chatbot system 222 may extract information about the user's association with other users to construct this social graph for submission. For an opportunity that specifies that the submitted applicant information include employment information, the chatbot system 222 may extract employment information from a user profile on the social network (e.g., LINKEDIN®). As discussed with respect to FIG. 10, the chatbot system 222 first attempt to extract as much applicant information from the social media account of the user to fill as many slot filling nodes of the current decision tree associated with the “apply to” intent, and then may prompt the user to provide other applicant information that could not be gleaned from the social media account. In certain embodiments, the process 450 of FIG. 12 may be repeated, as indicated by the arrow 460, until all of the relevant social media accounts of the user have been accessed and any relevant applicant information extracted to apply for the opportunity.

The technical effects of this disclosure include a chatbot system that enables users to apply for opportunities via a natural language chat interface. The chatbot system can receive a message (e.g., a natural language request) from a user and determine that the intent of the user message is to apply for a particular opportunity. In response, the chatbot may collect applicant information from various sources to enable the user to apply for the opportunity. In certain embodiments, the chatbot may extract applicant information from images of user documents or from social media accounts of the user. In certain embodiments, the chatbot system enables the user to simultaneously apply for multiple opportunities and/or to apply for opportunities on external services. As such, the disclosed chatbot system enhances the user experience by enabling the application process to proceed via natural language messages and prompts, reducing the amount of applicant information that is provided directly by the user, reducing the number of mistakes in the application process, and maximizing the benefit to the user by enabling the application to multiple or different opportunities with minimal additional effort.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A chatbot system, comprising:
at least one processor configured to execute instructions stored in at least one memory to cause the chatbot system to perform actions comprising:
receiving, via a chat interface of the chatbot system, a message from a user of a communicatively coupled client device, wherein the message includes an intent of the user to submit an application form;
determining applicant information fields of the application form;
determining applicant information of the user for each of the applicant information fields of the application form; and
populating the application form with the applicant information and submitting the application form.

2. The chatbot system of claim 1, wherein, to determine the applicant information of the user, the at least one processor is configured to execute the instructions stored in the at least one memory to cause the chatbot system to perform actions comprising:
providing, via the chat interface, a request to the client device for an image of a document;
receiving, via the chat interface, the image of the document from the client device; and
extracting the applicant information for some or all of the applicant information fields from the image of the document.

3. The chatbot system of claim 1, wherein, to determine the applicant information of the user, the at least one processor is configured to execute the instructions stored in the at least one memory to cause the chatbot system to perform actions comprising:
providing, via the chat interface, a request to the client device to authorize access to a social media account of the user;
receiving, via the chat interface, a response from the client device authorizing access to the social media account of the user; and
extracting the applicant information for some or all of the applicant information fields from the social media account of the user.

4. The chatbot system of claim 1, wherein, to receive the applicant information of the user, the at least one processor is configured to execute the instructions stored in the at least one memory to cause the chatbot system to perform actions comprising:
providing, via the chat interface, a request to the client device for the user to provide the applicant information for at least a third portion of the applicant information fields; and
receiving, via the chat interface, a response from the client device that includes the applicant information for some or all of the applicant information fields.

5. The chatbot system of claim 1, wherein, to submit the application form, the at least one processor is configured to execute the instructions stored in the at least one memory to cause the chatbot system to perform actions comprising:
determining, based on the applicant information, whether the user qualifies for an opportunity associated with the application form; and
providing, via the chat interface, a notification to the client device indicating whether the user qualifies for the opportunity.

6. The chatbot system of claim 5, wherein, to provide the notification, the at least one processor is configured to execute the instructions stored in the at least one memory to cause the chatbot system to perform actions comprising:
in response to determining that the user qualifies for the opportunity, providing, via the chat interface, a first set of information to the client device for the user to accept or use the opportunity; and
in response to determining that the user does not qualify for the opportunity, providing, via the chat interface, a second set of information to the client device regarding other opportunities to which the user can apply via the chat interface using the applicant information.

7. The chatbot system of claim 1, wherein the at least one memory is configured to store chatbot configuration information, opportunity information, the applicant information, or any combination thereof.

8. The chatbot system of claim 7, wherein the chatbot configuration information defines the intent for the user to submit the application form, wherein the intent is associated with a decision tree in chatbot configuration information, and the decision tree includes a respective slot filling node for each of the applicant information fields.

9. The chatbot system of claim 1, wherein the application form comprises an application for the user to apply to a promotional giveaway, an employment opportunity, an educational opportunity, a lending or banking opportunity, or a utility service opportunity.

10. The chatbot system of claim 1, wherein the applicant information comprises birth date, age, gender, address, employment status, educational history, purchase history, social media account information, or any combination thereof.

11. A method of operating a chatbot system, comprising:
receiving, via a chat interface of the chatbot system, a message from a user of a communicatively coupled client device, wherein the message includes an intent of the user to submit an application form;
determining applicant information fields of the application form;
determining applicant information of the user for each of the applicant information fields of the application form; and
populating the application form with the applicant information and submitting the application form.

12. The method of claim 11, wherein receiving the message of the user comprises:
performing intent matching of the message to determine the intent of the user based on locating, in the message of the user, keyphrases associated with the intent.

13. The method of claim 11, wherein receiving the message of the user comprises:
performing intent classification of the message to determine the intent of the user using a recurrent neural network (RNN) having a Long Short-Term Memory (LSTM) architecture.

14. The method of claim 11, wherein determining the applicant information of the user comprises:
extracting the applicant information for at least a first portion of the applicant information fields from an image of a document of the user received from the client device via the chat interface; and
extracting the applicant information for at least a second portion of the applicant information fields from a social media account of the user.

15. The method of claim 14, wherein determining the applicant information of the user comprises:
extracting the applicant information for at least a third portion of the applicant information fields from other messages received from the client device via the chat interface.

16. The method of claim 11, wherein submitting the application form comprises:
determining, based on the applicant information, whether the user qualifies for an opportunity associated with the application form; and
providing, via the chat interface, a notification to the client device indicating whether the user qualifies for the opportunity.

17. The method of claim 16, wherein providing the notification comprises:
in response to determining that the user qualifies for the opportunity, providing, via the chat interface, a first set of information to the client device for the user to accept or use the opportunity; and
in response to determining that the user does not qualify for the opportunity, providing, via the chat interface, a second set of information to the client device regarding other opportunities to which the user can apply via the chat interface using the applicant information.

18. One or more non-transitory, computer-readable media at least collectively storing instructions executable by a processor of a chatbot system, the instructions comprising instructions to:
receive, via a chat interface of the chatbot system, a message from a user of a communicatively coupled client device, wherein the message includes an intent of the user to submit an application form;
determine applicant information fields of the application form;
determine applicant information of the user for each of the applicant information fields of the application form; and
populate the application form with the applicant information and submit the application form.

19. The media of claim 18, wherein the instructions to determine the applicant information of the user comprise instructions to:
extract the applicant information for at least a first portion of the applicant information fields from an image of a document of the user received from the client device via the chat interface;
extract the applicant information for at least a second portion of the applicant information fields from a social media account of the user; and
extract the applicant information for at least a third portion of the applicant information fields from other messages received from the client device via the chat interface.

20. The media of claim 18, wherein the instructions to submitting the application form comprise instructions to:
determine, based on the applicant information, whether the user qualifies for an opportunity associated with the application form;
provide, via the chat interface, a notification to the client device indicating whether the user qualifies for the opportunity;
in response to determining that the user qualifies for the opportunity, provide, via the chat interface, a first set of information to the client device for the user to accept or use the opportunity; and
in response to determining that the user does not qualify for the opportunity, provide, via the chat interface, a second set of information to the client device regarding other opportunities to which the user can apply via the chat interface using the applicant information.
